(19) United States
(12) Patent Application Publication
(10) Pub. No.: US 2006/0147033 A1
(43) Pub. Date: Jul. 6, 2006

(54) Tying device for fastening personal item to a user

(75) Inventor: Kuo-Chang Chung, Wugu Township (TW)

Correspondence Address: TROXELL LAW OFFICE PLLC;SUITE 1404, 5205 LEESBURG PIKE, FALLS CHURCH, VA, 22041, US

(73) Assignee: Hsian Ming International Co., Ltd.

(21) Appl. No.: 11/017,819

(22) Filed: Dec. 22, 2004

(51) Int. Cl. H04M 1/00

(52) U.S. Cl. 379/428.01

(57) ABSTRACT

A tying device for fastening personal item to a user includes a cylindrical main body made of a material suitable for further finishing, a cord loop assembled to a first end of the main body, and at least a small-sized ring-shaped link assembled to an opposite second end of the main body. A hook-type catch or a connecting ring may be connected to the small-sized ring-shaped link directly or via a chain.

### FIELD OF THE INVENTION

The present invention relates to a tying device for fastening personal item to a user, and more particularly to a tying device that not only enables convenient tying of one or more personal items to a user without the risk of carelessly losing them, but also functions as an ornament matching the personal items held thereto.

### BACKGROUND OF THE INVENTION

When going out, most people would frequently carry along with them one or more personal items, such as mobile phone, digital camera, USB mass storage device, MP3, key ring, etc. Other diverse personal items, such as handbag, carry bag, and parasol usually carried with user's one hand, and wristlet, ring, or necklace usually worn on the user's body, are also frequently found with female users when they go out. Some of these personal items, such as mobile phone and key ring, are necessary in people's daily life, while others, such as wristlet, ring or necklace, are simply decorative ornaments.

These petty things carried along with the user, not only the small-sized items, but also some relatively big items, such as the mobile phone, are easily got lost and therefore often cause unnecessary troubles to the user.

By way of example, leather cases for mobile phones have been designed and manufactured for clamping to a user's waistband to avoid carelessly lost mobile phones. However, the mobile phone case must be removed from and re-clamped to the waistband each time the user changes clothes, and is therefore not convenient for use. Since the mobile phone case for clamping to the waistband is obviously not suitable for female users, a necklace-type ring has been developed for women to hang the mobile phone on the neck. The necklace-type ring is not suitable for holding other types of personal items to the user and looked less attractable.

### SUMMARY OF THE INVENTION

A primary object of the present invention is to provide a tying device for fastening personal item to a user, so that various kinds of personal items may be conveniently held to the user via the tying device without the risk of getting lost.

Another object of the present invention is to provide a tying device for fastening personal item to a user, so that the dying device itself forms an ornament of the personal item held thereto.

To achieve the above and other objects, the tying device for fastening personal item to a user includes a cylindrical main body made of a material suitable for further finishing, a cord loop assembled to a first end of the main body, and at least a small-sized ring-shaped link assembled to an opposite second end of the main body. A hook-type catch or a connecting ring may be connected to the small-sized ring-shaped link directly or via a chain.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a tying device for fastening personal item to a user according to a first embodiment of the present invention;

FIG. 2 is a perspective view of a tying device for fastening personal item to a user according to a second embodiment of the present invention;

FIG. 3 is a perspective view of a tying device for fastening personal item to a user according to a third embodiment of the present invention;

FIG. 4 shows the use of the tying device of FIG. 3 to connect a circular personal item, such as a ring, to an end thereof;

FIG. 5 shows the use of the tying device of FIG. 2 to connect a wristlet to an end thereof; and

FIG. 6 shows the use of the tying device of FIG. 3 to connect a mobile phone to an end thereof.

### DETAILED DESCRIPTION OF THE PREFERRED EMBODIMENTS

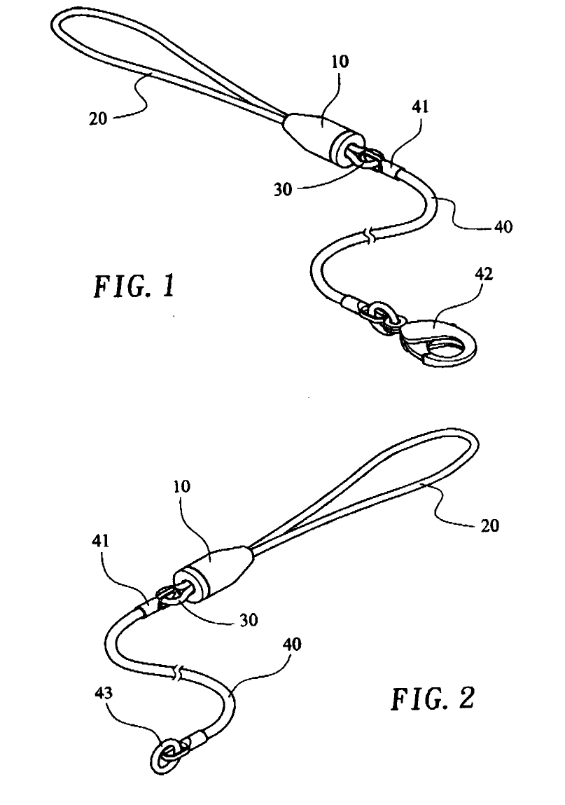

Please refer to FIG. 1, which is a perspective view of a tying device for fastening personal item to a user according to a first embodiment of the present invention. As shown, the tying device includes a substantially cylindrical main body 10, which is preferably made of a metal material suitable for further finishing, such as plating, a cord loop 20 assembled to and projected from a first end of the cylindrical main body 10, a small-sized ring-shaped link 30 assembled to and projected from an opposite second end of the cylindrical main body 10, and a chain 40 having an inner end 41 connected to the small-sized ring-shaped link 30 and an outer end connected to, for example, a hook-type catch 42.

FIG. 2 is a perspective view of a tying device for fastening personal item to a user according to a second embodiment of the present invention. The second embodiment is different from the first one in that the chain 40 is connected at the outer end to a connecting ring 43.

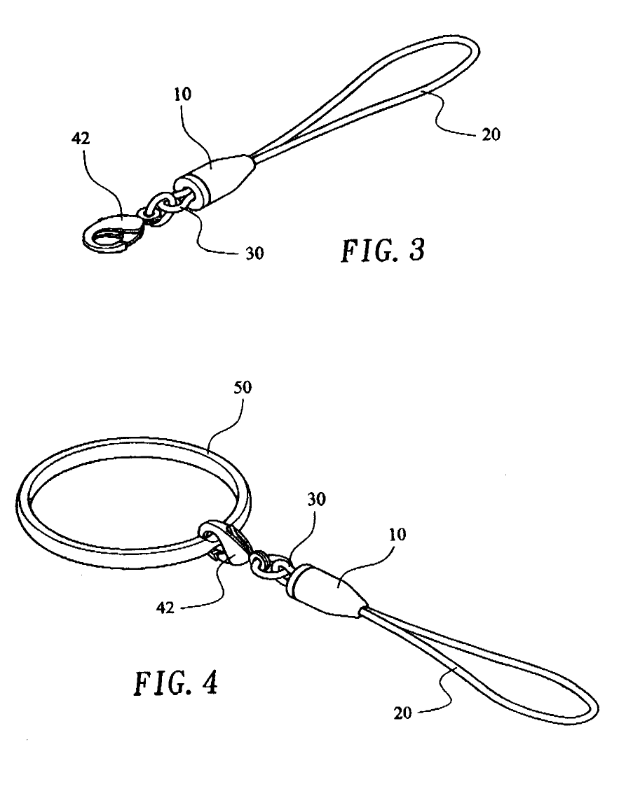

FIG. 3 illustrates a tying device for fastening personal item to a user according to a third embodiment of the present invention. The third embodiment is different from the first one in that the chain 40 is omitted and the hook-type catch 42 is directly assembled to the small-sized ring-shaped link 30.

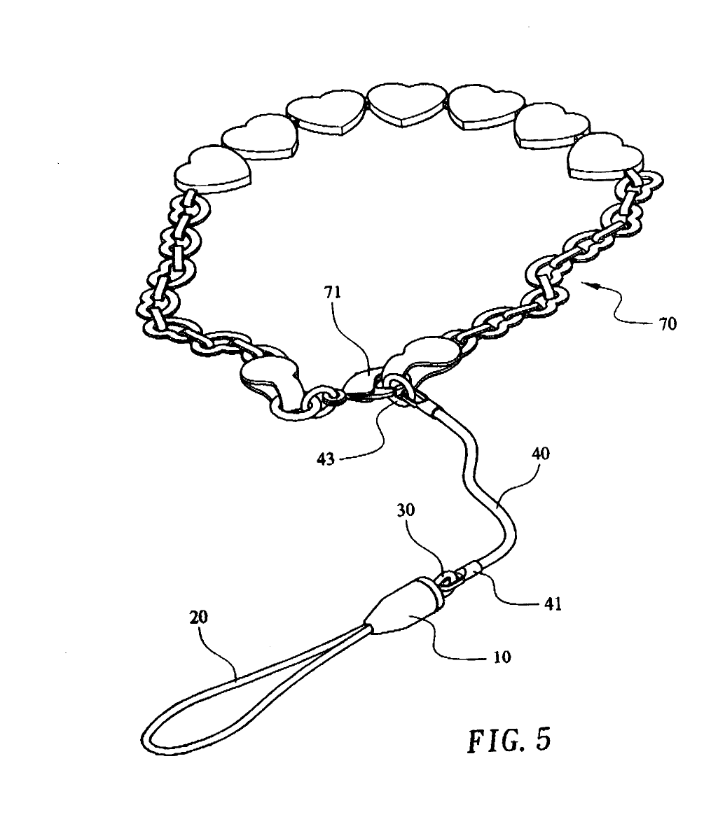

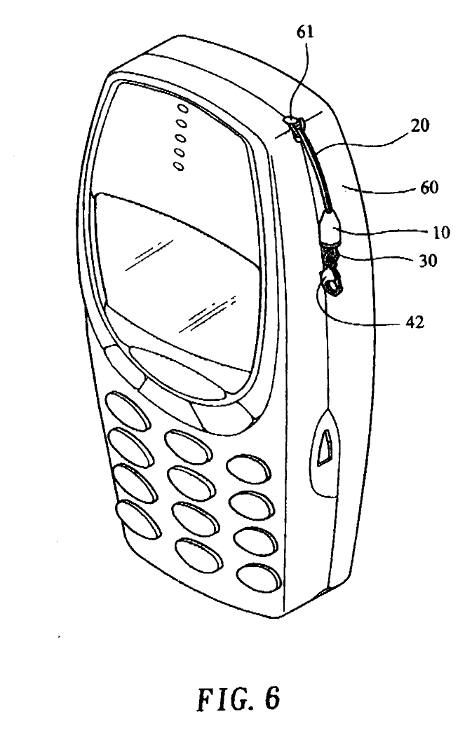

The tying device of the present invention having the hook-type catch 42 assembled to the outmost end thereof, as in the first or the third embodiment of the present invention, may be used to hold, for example, a circular ornament 50, such as a ring, to the hook-type catch 42, as shown in FIG. 4. Alternatively, the tying device of the first or the third embodiment may be connected at the cord loop 20 projected from the first end of the cylindrical main body 10 to a mobile phone 60 at a hanger 61 provided thereon, as shown in FIG. 6. And, the tying device of the present invention having the small-sized ring-shaped link 30 assembled to the outmost end thereof, as in the second embodiment of the present invention, may be used to hold an ornamental personal item, such as a wristlet 70, by connecting the ring-shaped link 30 to a catch or a hook 71 provided on the ornamental personal item, as shown in FIG. 5.

Since the cylindrical main body 10 of the tying device of the present invention has only the cord loop 20 and the small-sized ring-shaped link 30 separately connected to two ends thereof, it is possible for the main body 10 to have relatively small dimensions. When being used in a non-heavy-duty condition, the cylindrical main body 10 may have a diameter smaller than 0.5 cm and an overall length smaller than 1 cm. With such a small volume, the tying device of the present invention used to fasten one or more personal items to a user almost has not any adverse influence on the visual effect of the personal item or items held thereto. Meanwhile, it is possible for different accessories, including the link 30, the chain 40, and the hook-type catch 42 of the tying device of the present invention to have shapes and colors matching the personal items held thereto, so that the dying device itself functions as an ornament.

With the above arrangements, the tying device of the present invention may be, for example, connected at the cord loop 20 to a mobile phone 60, as shown in FIG. 6, and at the hook-type catch 42 to a handbag or a shoulder bag (not shown) carried by the user. The tying device of the present invention not only functions as means to avoid carelessly lost personal items, but also as a good ornament to highlight the personal items held thereto.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A tying device for fastening personal item to a user, comprising a cylindrical main body made of a material suitable for further finishing, a cord loop assembled to a first end of said main body, and at least a small-sized ring-shaped link assembled to an opposite second end of said main body.

2. The tying device for fastening personal item to a user as claimed in claim 1, further comprising a chain having an inner end assembled to said small-sized ring-shaped link and an outer end connected to a hook-type catch.

3. The tying device for fastening personal item to a user as claimed in claim 1, further comprising a chain having an inner end assembled to said small-sized ring-shaped link and an outer end connected to a connecting ring.

4. The tying device for fastening personal item to a user as claimed in claim 1, further comprising a hook-type catch assembled to said small-sized ring-shaped link.
